(19) United States
(12) Patent Application Publication
(10) Pub. No.: US 2025/0237412 A1
(43) Pub. Date: Jul. 24, 2025

(54) METHOD OF CREATING AND OPERATING A SUBTERRANEAN ENERGY STORAGE FIELD

(71) Applicant: SAGE GEOSYSTEMS INC., Bellaire, TX (US)

(72) Inventors: Robert Lance COOK, Houston, TX (US); Lev M. RING, Bellaire, TX (US); Cynthia D. TAFF, Kingwood, TX (US)

(21) Appl. No.: 18/849,196

(22) PCT Filed: Mar. 22, 2023
(86) PCT No.: PCT/US2023/064826

§ 371 Date: Sep. 20, 2024

Related U.S. Application Data
(60) Provisional application No. 63/323,884, filed on Mar. 25, 2022.

(51) Int. Cl. F24T 10/30; F03G 4/00; F03G 4/02; F24T 50/00

(52) U.S. Cl. CPC F24T 10/30; F03G 4/02; F03G 4/026; F03G 4/072; F24T 50/00; F03G 4/035; F03G 4/037

(57) ABSTRACT

A system and method of using a subterranean energy storage system includes a geothermal reservoir with at least one fracture configured to hold a working fluid for a period of time. At least one wellbore is positioned within the geothermal reservoir fluidly coupled to the at least one fracture. At least one pump is configured to at least one of a) inject the working fluid into the at least one fracture and b) withdraw the working fluid from the at least one fracture. A power system is fluidly coupled to the wellbore, the power system configured to convert at least one of a) a thermal energy of the working fluid and b) a fluid dynamic energy of the working fluid into an electrical current. A downhole pressure of the working fluid held in the at least fracture for the period of time increases during the period time.

### REFERENCE TO EARLIER FILED APPLICATIONS

The present application is an International Patent Application under the Patent Cooperation Treaty and claims priority to and the benefit of U.S. Provisional Patent Application Ser. No. 63/323,884 filed Mar. 25, 2022 and titled Method of Creating and Operating a Subterranean Energy Storage Filed, the disclosure of which is incorporated in its entirety by this reference.

### BACKGROUND

Energy storage is a major technical challenge for today's electrical grid as the cheapest sources of electricity, wind and solar, are intermittent and their availability does not always correspond to peak demand. This has created multiple new approaches to store their energy for later use during periods of peak demand. Energy storage approaches include pumped storage where water is pumped from a lower elevation reservoir to a higher elevation reservoir for later use to drive turbines as the water flows back towards the lower elevation reservoir; battery storage; compressed air/gas storage in underground caverns and/or in surface tankage; and gravity storage using weights and pullies. For significant grid scale storage all of these are expensive, inefficient, and require a large physical footprint at the surface.

The present application relates to subterranean energy storage systems, a type of geothermal and geopressured “battery” that is configured to store energy in a fractured geothermal reservoir during periods of off-peak energy demand and to return as much, and, in some instance, more energy than initially stored. In experiments and predicted results, the disclosed subterranean energy storage systems return much more energy than anticipated and, in some instances, more energy than initially stored. This stored and then released energy then may be used during periods of higher or even peak energy demand.

The disclosed subterranean energy storage system and its equivalents offer many advantages, including a minimal surface footprint as most of the storage occurs in the subsurface and at scale compared to other industrial and even utility scale systems; the approach appears cheaper than the currently available technologies in experimental results and anticipated modeling; and using off-peak energy to compress a working fluid and storing it in a hot reservoir delivers more energy through the addition of geothermal heat and/or geothermal pressure than the input energy required to compress and inject the working fluid. In other words, storage in a contained subterranean fracture network results in additional energy in the working fluid through geothermal heating.

### BRIEF SUMMARY

This disclosure relates to a system, methods, and composition for creating a subterranean storage reservoir of variable volume using subsurface fracking to create an extensive but contained fracture network or networks which compress a working fluid or working gas (referred to going forward as the working fluid) and pressurize the working fluid in the artificially created reservoir where it is also further heated by the earth such that the working fluid expands over time to a pressure greater than the pressure at which the working fluid was injected. The injection of the working fluid into the fracture network and its further pressurization through heating by geothermal energy then forces the downhole fracture network to dilate but remain contained like the opening of a blacksmith's bellows or an accumulator bottle being charged. When the stored energy subsequently is discharged after a period of time the load of the earth's overburden drives the fracture networks in the reservoir to close and to expel the fluid. The compressed and heated working fluid from the reservoir is then produced to surface and either used for direct heating or is put directly through a turbine or through a heat exchanger turbine arrangement to generate electricity.

An example of a subterranean energy storage system includes a geothermal reservoir with at least one fracture configured to hold a working fluid for a period of time. At least one wellbore is positioned within the geothermal reservoir fluidly coupled to the at least one fracture. At least one pump optionally may be fluidly coupled to the wellbore. The at least one pump is configured to at least one of a) inject the working fluid into the at least one fracture of the geothermal reservoir and b) withdraw the working fluid from the at least one fracture of the geothermal reservoir. A power system is fluidly coupled to the at least one wellbore. The power system is configured to convert at least one of a) a thermal energy of the working fluid and b) a fluid dynamic energy of the working fluid into an electrical current. A downhole pressure of the working fluid held in the at least fracture for the period of time increases during the period time. The period of time may be of any duration so long as the downhole pressure increases, but typically is greater than one hour.

The subterranean energy storage system may also include one or more of the following, in any combination. The electrical current converted by the power system may be greater than a sum of i) an injection energy to inject the working fluid into the geothermal reservoir, ii) a withdrawal energy to withdraw the working fluid from the geothermal reservoir, and iii) a lost energy of a portion of the working fluid unrecoverable from the geothermal reservoir.

A permeability of the geothermal reservoir may be between 10⁻⁶ to 10⁻⁸ darcies. A darcy is a standard unit of measure of permeability. One darcy describes the permeability of a porous medium through which the passage of one cubic centimeter of fluid having one centipoise of viscosity flowing in one second under a pressure differential of one atmosphere where the porous medium has a cross-sectional area of one square centimeter and a length of one centimeter. A millidarcy (mD) is one thousandth of a darcy. Optionally, a majority—over 50%—of the working fluid is returnable to the surface and, more preferably, 90% is returnable, and yet more preferably still, more than 95% is returnable, and even more preferably at least 99% of the working fluid is returnable.

Optionally, in more porous formations, the subterranean energy storage system may include a sealant, such as cement, resin, or other impermeable materials—or at least relatively less permeable than the geothermal reservoir—may be injected into the geothermal reservoir to create a sealed portion or section of the geothermal reservoir around the periphery of the geothermal reservoir wear the sealed portion is less permeable than the native (untreated) geothermal reservoir. This sealed portion could reduce or eliminate leak-off of all or a portion of the working fluid that would otherwise make the more porous formation economically unviable for use as a subterranean energy storage system.

Optionally, the at least one wellbore includes a plurality of wellbores, which may include one or more vertical, deviated, and/or horizontal wellbores in any combination. The at least one fracture includes a plurality of fractures. The fracture or fractures may extend in any direction, although they may be preferentially steered downwards. For example, the at least one fracture or plurality of fractures may extend away from the at least one wellbore and downward towards a center of the Earth. The at least one fracture optionally may be configured to open when the at least one pump injects the working fluid into the geothermal reservoir and to close when the working fluid is withdrawn from the geothermal reservoir.

The subterranean energy storage system optionally includes a valve configured to hold the working fluid in the at least one fracture when the valve is in a closed position and to allow the working fluid to flow from the at least one fracture to the power generation system when the valve is in an open position. The working fluid may be configured to flow from the at least one fracture to the power generation system under an influence of a geostatic pressure when the valve is in the open position. The geostatic pressure, or lithostatic pressure, is the pressure of the weight of overburden, or overlying rock, on the reservoir. The geostatic pressure will exert pressure and force the working fluid from the at least one fracture when the hydrostatic pressure of the working fluid (or other fluids) in the at least one wellbore is less than the geostatic pressure.

The working fluid optionally may be any fluid. For example, the working fluid may be at least one of a) fresh water; b) brine; c) ammonia; d) a hydrocarbon; e) a liquid; f) a gas; g) a supercritical fluid and/or combinations thereof. As another example, brine may be typically greater than 2 parts per thousand of dissolved salt, typically sodium and chloride, but other salts are included in this definition. Other examples of fluids include, but are not limited to, ammonia, benzene, other hydrocarbons, organic compounds, other liquids, other gases, and the like. Fluid is defined to include both liquids, gases, and supercritical fluids. A supercritical fluid is any substance at a temperature and pressure above its critical point where distinct liquid and gas phases do not exist, but below the pressure at which the substance becomes a solid. Optionally, the working fluid may be supercritical water, supercritical carbon dioxide, supercritical ammonia, and so forth.

The power system may be at least one of a) a surface turbine of any known type, such as organic Rankine cycle, Brayton cycle, and the like and b) a downhole turbine positioned within the at least one wellbore.

Optionally, the at least one pump may be configured to inject the working fluid during an off-peak period of power consumption and optionally the at least one pump may be configured to withdraw the working fluid during a peak period of power consumption. Peak demand typically is the highest amount of energy required of a system during a period of time, typically in quarter, half, or full hour increments during a period of time, often a day. Off-peak period is any time that is not peak demand, but more typically is a period of lowest amount of energy required of a system during a period of time, typically in quarter, half, or full hour increments during a period of time, often a day. The at least one pump may include a plurality of pumps. The at least one pump may be located at the surface or it may be a submersible pump positioned in the at least one wellbore. The at least one pump may include one or more of a centrifugal pump, a positive displacement pump, a booster pump, a reciprocating plunger pump, a progressive cavity pump, a gear pump, a diaphragm pump, and a metering pump.

Optionally, a downhole temperature of the geothermal reservoir is of any temperature and, in some examples, is at least 300 degrees Fahrenheit or 149 degrees Celsius.

Methods of storing energy in a subterranean energy storage system are also disclosed.

A method may include injecting a working fluid through at least one wellbore positioned within the geothermal reservoir and into at least one fracture in the geothermal reservoir; holding the working fluid in the at least one fracture for a period of time so that at least one of a downhole temperature of the working fluid and the downhole pressure of the working fluid increases; withdrawing the working fluid from the at least one fracture, after the period of time, and passing the working fluid through a power system fluidly coupled to the wellbore; and, converting at least one of a) a thermal energy of the working fluid and b) a fluid dynamic energy of the working fluid into an electrical current with a power system fluidly coupled to the at least one wellbore. This method optionally may be performed with the system described above.

The method may also include at least one of opening the at least one fracture when injecting the working fluid into the geothermal reservoir and closing the at least one fracture when withdrawing the working fluid from the geothermal reservoir. The method optionally includes withdrawing the working fluid from the at least one fracture comprises at least one withdrawing the working fluid at least partly under an influence of a geostatic pressure. The method may also include fracturing the geothermal reservoir such that the at least one fracture extends away from the at least one wellbore and downward towards a center of the Earth. The method of fracturing the geothermal reservoir may include any known method of fracturing a reservoir, including hydraulic fracturing, acid fracturing, and the like. For example, the method of fracturing the reservoir may be performed using the method disclosed in International Patent Application No. PCT/US2021/037965 titled Systems, Method, and Composition for Geothermal Heat Harvest filed Jun. 17, 2021, the disclosure of which is incorporate in its entirety by this reference.

As used herein, “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

Various embodiments of the present inventions are set forth in the attached figures and in the Detailed Description as provided herein and as embodied by the claims. It should be understood, however, that this Summary does not contain all of the aspects and embodiments of the one or more present inventions, is not meant to be limiting or restrictive in any manner, and that the invention(s) as disclosed herein is/are and will be understood by those of ordinary skill in the art to encompass obvious improvements and modifications thereto.

Additional advantages of the present invention will become readily apparent from the following discussion, particularly when taken together with the accompanying drawings.

### BRIEF DESCRIPTION OF THE DRAWINGS

To further clarify the above and other advantages and features of the one or more present inventions, reference to specific embodiments thereof are illustrated in the appended drawings. The drawings depict only typical embodiments and are therefore not to be considered limiting. One or more embodiments will be described and explained with additional specificity and detail through the use of the accompanying drawings in which:

FIG. 1 is a geothermal power system coupled to an embodiment of a downhole heat exchanger.

FIG. 2 is a simplified example of the geothermal power system of FIG. 1 and a subterranean energy storage system.

FIG. 3 is a flow chart of a method of storing energy in the subterranean energy storage system of FIG. 2.

FIGS. 4A-4C are temperature and pressure data versus time for a recent field test demonstrating the system and method.

FIGS. 5A-5D are an idealized view of a fracture around a wellbore at different pressures during an energy storage cycle.

FIG. 6 is an idealized view of a fracture around a wellbore at different pressures and different times during an energy storage cycle.

FIG. 7 is a graph of the pore pressure, fracture gradient, casing depth, and other relevant data for the recent field test illustrated in FIGS. 4A-4C.

Common element numbers represent common features, even if the appearance of a feature varies slightly between the figures.

The drawings are not necessarily to scale.

### DETAILED DESCRIPTION

The present invention will now be further described. In the following passages, different aspects of the embodiments of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

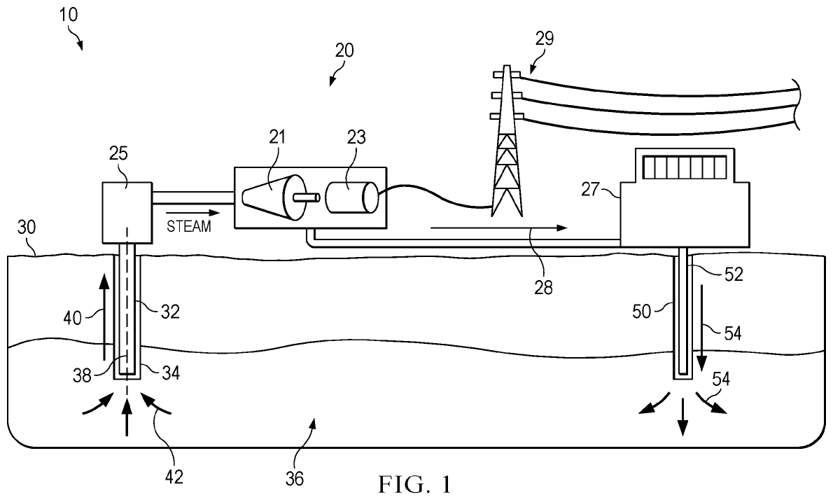

An idealized geothermal power system 10 includes a power generation unit 20 located on the Earth's surface 30 as illustrated in FIG. 1. The power generation unit 20 may be of any type that converts heat to electricity and may include any one or more of a turbine 21, generator 23, expansion unit 25, cooling unit 27 to receive the relatively cooler steam and/or water 28 from the turbine 21, and electricity transmission system 29. Some examples of representative power generation units include direct dry steam plants, flash plants, binary plants, combined-cycle or hybrid plants, and so forth, that receive heated fluid from surface or subsurface sources of heat.

The geothermal power system 10 also includes at least one tubing 32 that is configured to be positioned within a wellbore 34, the wellbore 34, in turn, being positioned in a subterranean geothermal source 36 or reservoir to return heated water or other heated working fluid 40 (including gases, liquids, and supercritical fluids such as supercritical carbon dioxide) that is heated via direct or indirect contact with any rock and/or fluid 42 in the geothermal source 36. Additionally, or alternatively, the at least one tubing 32 may be positioned within or along a source of heat on the surface. The at least one tubing is hydraulically coupled to the power generation unit 20. The at least one tubing includes a longitudinal axis 38.

The geothermal power system 10 optionally includes an injection well 50 and optionally at least one injection tubing 52 to inject cooled water or other working fluid (for example, supercritical carbon dioxide) 54 into the geothermal source 36.

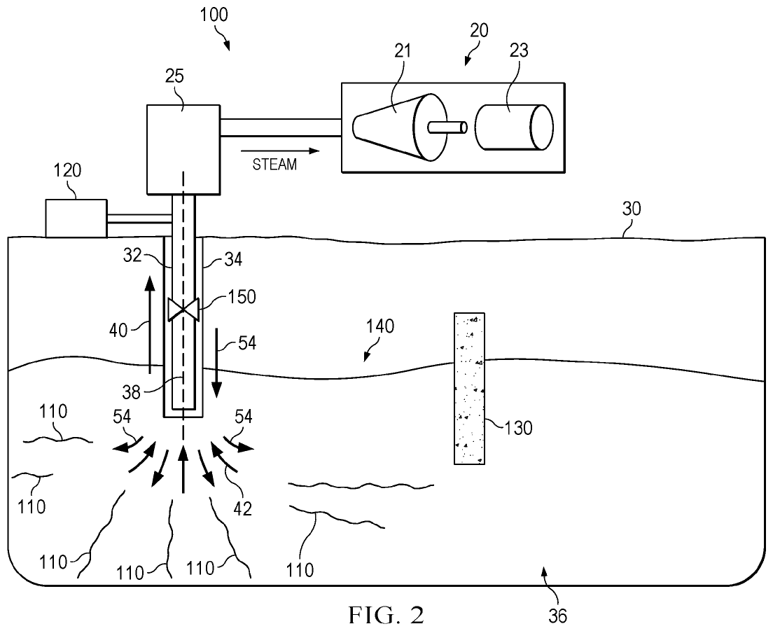

FIG. 2 illustrates a simplified version of the geothermal power system 10 with some optional elements elided for clarity. Stated differently, the subterranean energy storage system 100 of FIG. 2 may be used with any combination of the components discussed with respect to FIG. 1. The subterranean energy storage system 100 includes a geothermal source or geothermal reservoir 36 with at least one fracture 110 configured to hold a working fluid for a period of time. The least one wellbore 34 is positioned within the geothermal reservoir 36 and is fluidly coupled to the at least one fracture 110. At least one pump 120 optionally may be fluidly coupled to the wellbore 34. The at least one pump 120 is configured to at least one of a) inject the working fluid into the at least one fracture 110 of the geothermal reservoir 36 and b) withdraw the working fluid from the at least one fracture 110 of the geothermal reservoir 36. Optionally, the injection and extraction of the working fluid occurs through the at least one wellbore 34, i.e., the same wellbore, although the injection of the working fluid may occur in an injection well 50 and be withdrawn or extracted from the at least one wellbore 34 as illustrated in FIG. 1.

A power system 20, or power generation unit 20, is fluidly coupled to the at least one wellbore 34. The power system 20 is configured to convert at least one of a) a thermal energy of the working fluid and b) a fluid dynamic energy of the working fluid into an electrical current. A downhole pressure of the working fluid held in the at least fracture 110 for the period of time increases during the period time. The period of time may be of any duration so long as the downhole pressure increases over time, but typically is greater than one hour.

The subterranean energy storage system 100 may also include one or more of the following, in any combination. The electrical current converted by the power system 20 may be greater than a sum of i) an injection energy to inject the working fluid into the geothermal reservoir 36, ii) a withdrawal energy to withdraw the working fluid from the geothermal reservoir 36, and iii) a lost energy of a portion of the working fluid unrecoverable from the geothermal reservoir.

A permeability of the geothermal reservoir 36 may be between 10⁻⁶ to 10⁻⁸ darcies. A darcy is a standard unit of measure of permeability. One darcy describes the permeability of a porous medium through which the passage of one cubic centimeter of fluid having one centipoise of viscosity flowing in one second under a pressure differential of one atmosphere where the porous medium has a cross-sectional area of one square centimeter and a length of one centimeter. A millidarcy (mD) is one thousandth of a darcy. Optionally, a majority—over 50%—of the working fluid is returnable to the surface and, more preferably, 90% is returnable, and yet more preferably still, more than 95% is returnable, and even more preferably at least 99% of the working fluid is returnable.

Optionally, in more porous formations, the subterranean energy storage system 100 may include a sealant 130, such as cement, resin, or other impermeable materials—or at least relatively less permeable than the geothermal reservoir—may be injected into the geothermal reservoir to create a sealed portion 140 or section of the geothermal reservoir 36 around the periphery of the geothermal reservoir where the sealed portion 140 is less permeable than the native (untreated) geothermal reservoir 36. This sealed portion 140 could reduce or eliminate leak-off of all or a portion of the working fluid that would otherwise make the more porous formation economically unviable for use as a subterranean energy storage system 100.

Optionally, the at least one wellbore 36 includes a plurality of wellbores, which may include one or more vertical, deviated, and/or horizontal wellbores in any combination.

The at least one fracture 110 includes a plurality of fractures. The at least one fracture 110 or fractures may extend in any direction, although they may be preferentially steered downwards. For example, the at least one fracture 110 or plurality of fractures may extend away from the at least one wellbore and downward towards a center of the Earth. The at least one fracture 110 optionally may be configured to open when the at least one pump 120 injects the working fluid into the geothermal reservoir 36 and to close when the working fluid is withdrawn from the geothermal reservoir 36.

The subterranean energy storage system 100 optionally includes a valve 150 configured to hold the working fluid in the at least one fracture 110 when the valve 150 is in the closed position and to allow the working fluid to flow from the at least one fracture 110 to the power generation system 20 when the valve 150 is in the open position. The working fluid may be configured to flow from the at least one fracture 110 to the power generation system 20 under an influence of a geostatic pressure when the valve 150 is in the open position. The geostatic pressure, or lithostatic pressure, is the pressure of the weight of overburden, or overlying rock, on the geothermal reservoir 36. The geostatic pressure will exert pressure and force the working fluid from the at least one fracture 110 when the hydrostatic pressure of the working fluid (or other fluids) in the at least one wellbore 34 is less than the geostatic pressure.

The working fluid optionally may be any fluid. For example, the working fluid may be at least one of a) fresh water; b) brine; c) ammonia; d) a hydrocarbon; e) a liquid; f) a gas; g) a supercritical fluid and/or combinations thereof. As another example, brine may be typically greater than 2 parts per thousand of dissolved salt, typically sodium and chloride, but other salts are included in this definition. Other examples of fluids include, but are not limited to, ammonia, benzene, other hydrocarbons, organic compounds, other liquids, other gases, and the like. Fluid is defined to include both liquids, gases, and supercritical fluids. A supercritical fluid is any substance at a temperature and pressure above its critical point where distinct liquid and gas phases do not exist, but below the pressure at which the substance becomes a solid. Optionally, the working fluid may be supercritical water, supercritical carbon dioxide, supercritical ammonia, and so forth.

The power system 20 may be at least one of a) a surface turbine of any known type, such as organic Rankine cycle, Brayton cycle, and the like and b) a downhole turbine positioned within the at least one wellbore.

Optionally, the at least one pump 120 may be configured to inject the working fluid during an off-peak period of power consumption and optionally the at least one pump 120 may be configured to withdraw the working fluid during a peak period of power consumption. Peak demand typically is the highest amount of energy required of a system during a period of time, typically in quarter, half, or full hour increments during a period of time, often a day. Off-peak period or off-peak demand is any time that is not peak demand, but more typically is a period of lowest amount of energy required of a system during a period of time, typically in quarter, half, or full hour increments during a period of time, often a day. The at least one pump 120 may include a plurality of pumps. The at least one pump 120 may be located at the surface, as illustrated, or it may be a submersible pump positioned in the at least one wellbore. The at least one pump 120 may include one or more of a centrifugal pump, a positive displacement pump, a booster pump, a reciprocating plunger pump, a progressive cavity pump, a gear pump, a diaphragm pump, a metering pump, and other similar pumps.

Optionally, a downhole temperature of the geothermal reservoir 36 is of any temperature and, in some examples, is at least 300 degrees Fahrenheit or 149 degrees Celsius.

Methods of storing energy in a subterranean energy storage system are also disclosed.

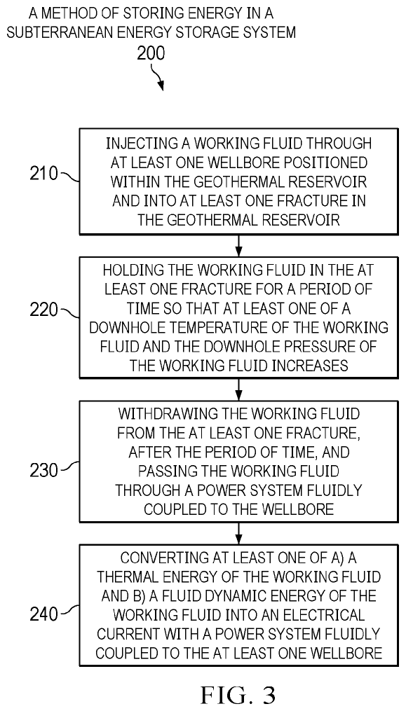

A method 200, illustrated in FIG. 3, may include injecting a working fluid through at least one wellbore positioned within the geothermal reservoir and into at least one fracture in the geothermal reservoir 210; holding the working fluid in the at least one fracture for a period of time so that at least one of a downhole temperature of the working fluid and the downhole pressure of the working fluid increases 220; withdrawing the working fluid from the at least one fracture, after the period of time, and passing the working fluid through a power system fluidly coupled to the wellbore 230; and, converting at least one of a) a thermal energy of the working fluid and b) a fluid dynamic energy of the working fluid into an electrical current with a power system fluidly coupled to the at least one wellbore 240. This method optionally may be performed with the system 10 and 100 described above.

The method 200 may also include any of the following steps (not illustrated), in any order, as one of skill in the art would appreciate: at least one of opening the at least one fracture 110 when injecting the working fluid into the geothermal reservoir 36 and closing the at least one fracture 110 when withdrawing the working fluid from the geothermal reservoir 36. The method 200 optionally includes withdrawing the working fluid from the at least one fracture 110 comprises at least one withdrawing the working fluid at least partly under an influence of a geostatic pressure. The method 200 may also include fracturing the geothermal reservoir 36 such that the at least one fracture 110 extends away from the at least one wellbore and downward towards a center of the Earth. The method of fracturing the geothermal reservoir may include any known method of fracturing a reservoir, including hydraulic fracturing, acid fracturing, and the like.

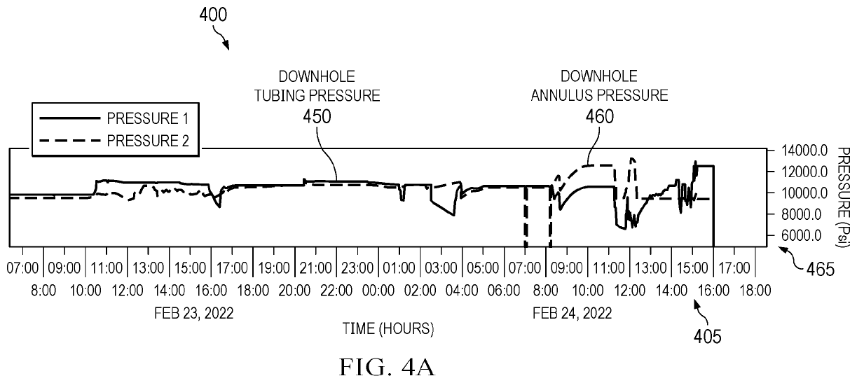

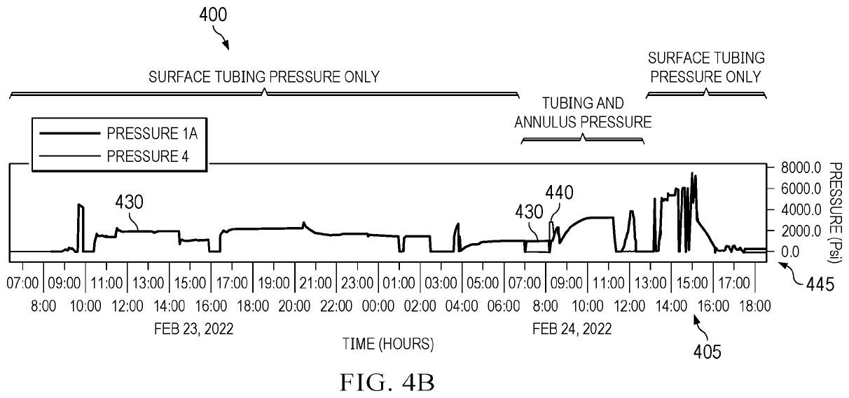

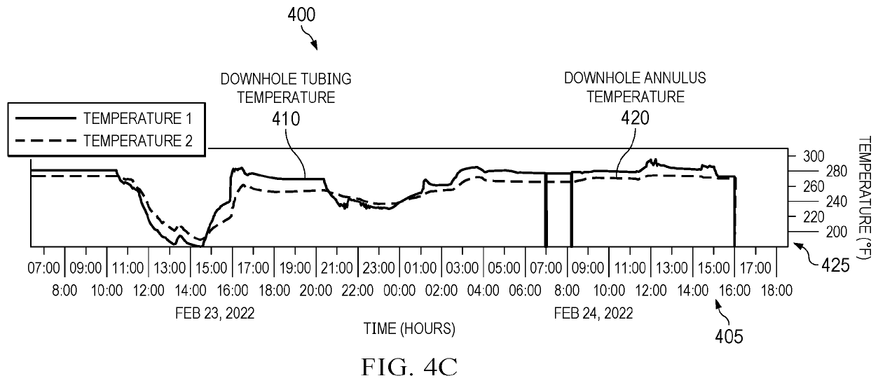

An example of a field test of the above disclosed system will now be discussed. FIGS. 4A-4C show an unexpected result from recent field tests performed on Feb. 23 and 24, 2022 in Starr County, Texas. Three time-synchronized data plots 400 are presented with time in hours on the X-axis 405 in FIGS. 4A-4C. The data include downhole tubing pressure 450 and downhole annulus pressure 460 with right-hand Y-axis 465 of 5000 pounds per square inch (34.47 Megapascal) to 8000 pounds per square inch (96.53 Megapascal) in FIG. 4A; surface tubing pressure 430 and surface annulus pressure 440 with right-hand Y-axis 445 of 0 pounds per square inch (0 Megapascal) to 8000 pounds per square inch (55.16 Megapascal) in FIG. 4B; and downhole tubing temperature 410 and downhole annulus temperature 420 with right-hand Y-axis 425 of 180 degrees Fahrenheit (82.2 degrees Celsius) to 300 degrees Fahrenheit (148.9 degrees Celsius) in FIG. 4C.

Normally after fracture operations, the pumps are shut down and the pressure is allowed to bleed off to the surrounding geology/formation. Immediately after the pumps are shut down the fracture network—i.e., the one or more fractures created during the fracture operation—is held open by the pressurized fluid. However, as the pressure bleeds off into the formation, the one or more fractures gradually close and there is an inflection in the pressure bleed off after the fracture closes. This loss of pressure to the surrounding reservoir means that subterranean storage of energy in fractured reservoirs would be unattractive as this bleed off represents a loss in stored energy. (This is like storing a compressed gas in a cylinder with a leak.)

Unexpectedly and as can be seen in the field data, after fracking a tight shale at 11,000 feet (3,353 meters) with a bottomhole temperature over 290 degrees Fahrenheit (143 degrees Celsius), no observable pressure leak-off or loss of stored energy from the frack job occurred. More surprisingly, a slight increase in the downhole annulus pressure 460 (FIG. 4A) occurred as the water based frack fluid increased in temperature over the approximately 4 hours (around 16:30 to 20:30 hours; FIG. 4C).

This single test demonstrated that a pump or plurality of pumps could be used to pump a fluid into a formation and create a subsurface reservoir. In this example, 400 barrels (bbls; 63.60 kiloliters) were injected to create the fracture network in the reservoir. This example is evidence that in a reservoir rock or formation of a certain type that energy could be stored for extended periods and system energy can be augmented through the subterranean geothermal heating of the injected fluid.

In this field example, the fracturing fluid or injectant was water-based fluid, whose density does not change greatly when heated. A working fluid for a subterranean energy storage system may more efficiently use another fluid to convert geothermal heat energy to additional pressure to drive a turbine more effectively when produced to the wellbore and/or the surface. For example, super critical carbon dioxide or a commercial refrigerant could be used.

If the fractured or artificial reservoir were “leaky,” or a formation that allows the working fluid to leak off into the rock matrix or natural fractures surrounding the artificially created downhole reservoir, as most anyone skilled in subsurface geology would predict is the usual situation, losses from leakage of such expensive working fluids would make such an approach uneconomical. But given these recent unexpected and surprising findings, downhole energy storage and energy enhancement in an artificially created downhole reservoir located geographically where needed, becomes not only a realistic but a very attractive possibility.

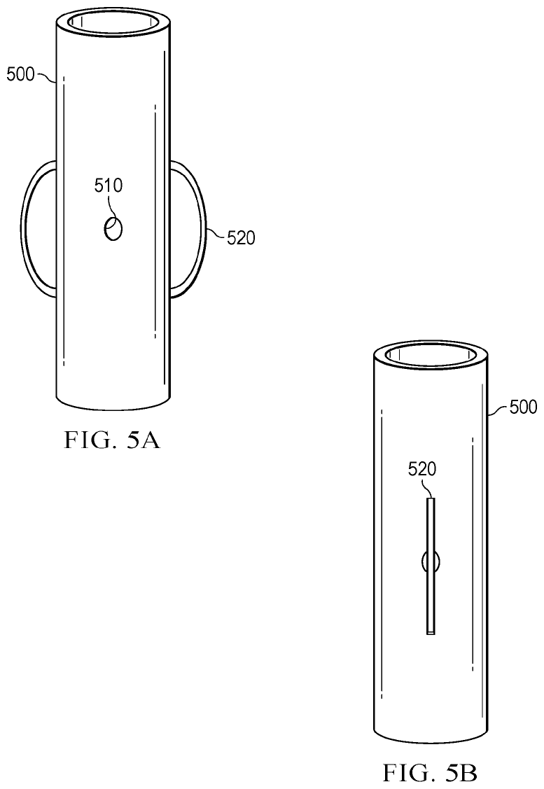

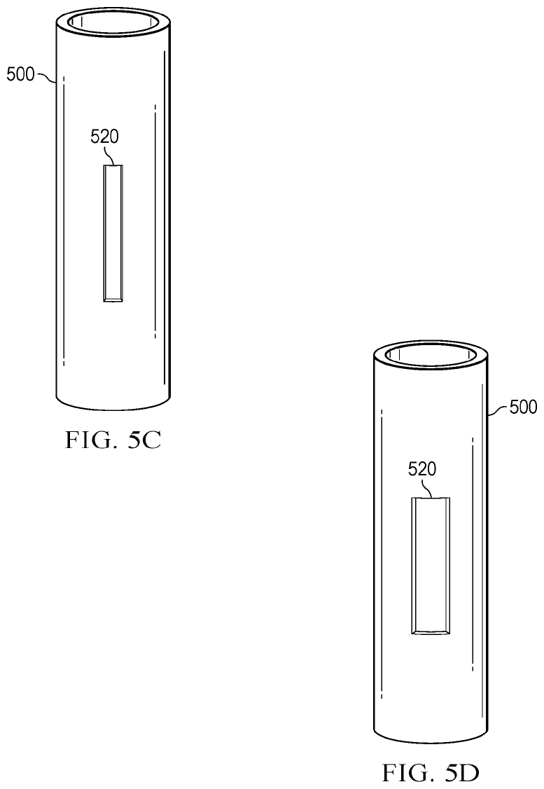

FIGS. 5A-5D illustrates an idealized representation of how the fracture or fractures in a geothermal reservoir would dilate during the injection cycle. Well casing 500 is an idealized portion of the wellbore 36 with a casing perforation 510 and a fracture (or “frack”) 520 that one can imagine is a perfect penny shaped fracture that exists around a casing perforation 510. FIG. 5A illustrates a front view of the fracture 520 growing around the perforation 510 in the casing 500. FIG. 5B is a side view of FIG. 5A when the surface pressure added from the pump 120 plus the hydrostatic head of the fluid in the wellbore 36 approaches the fracture opening/closing pressure. As representationally illustrated in FIG. 5B, the fracture 520 is relatively narrow. In FIG. 5C, also a side view like FIG. 5B, the increased surface pressure from the pump 120 (added to the hydrostatic head) has increased to mid-cycle (i.e., not yet at peak pressure) and the fracture 520 is relatively larger/wider than in FIG. 5B as the pressure of the working fluid acts to open and/or extend the fracture 520 into the geothermal reservoir 36 and away from the wellbore 34. In FIG. 5D, also a side view, the yet further increased surface pressure from the pump 120 (added to the hydrostatic head) has increased to the fracture propagation pressure of the formation into which the fracture 520 is opening/extending.

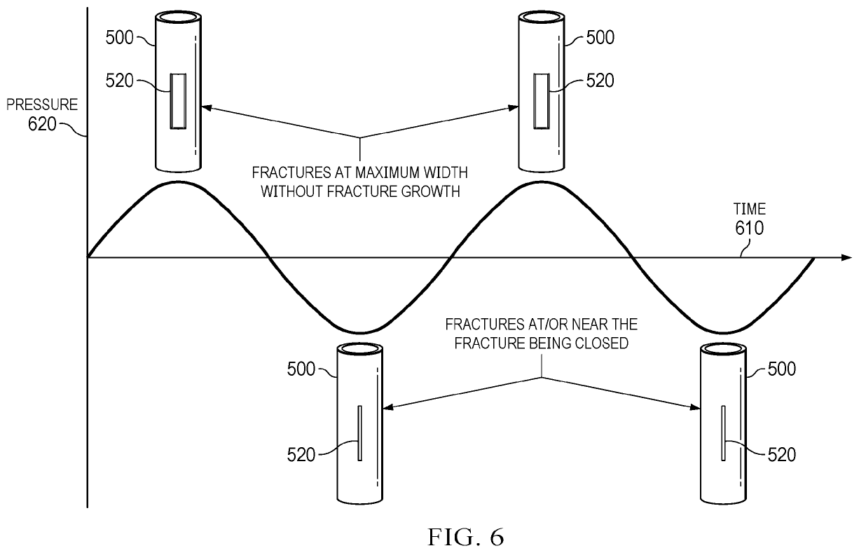

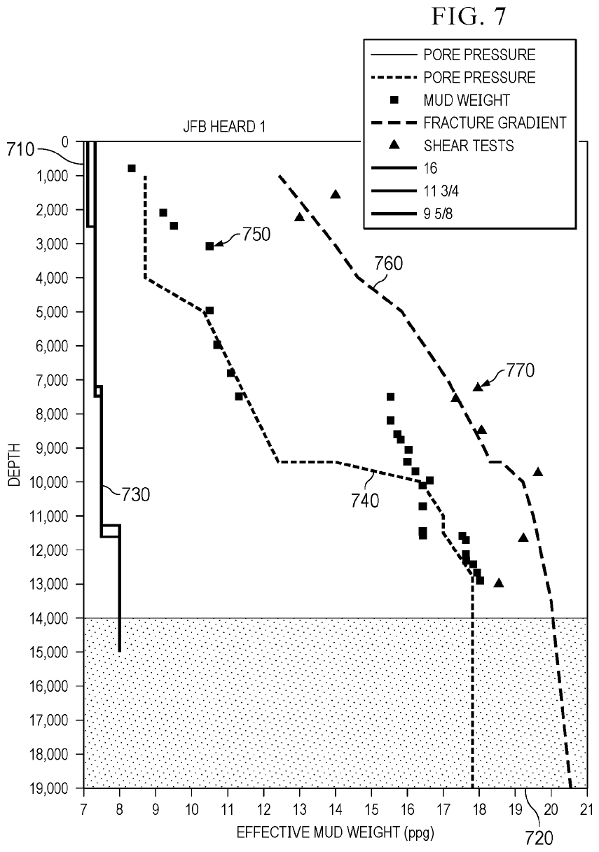

FIG. 6 illustrates the idealized fractures 520 of FIGS. 5A-5D against an idealized representation of time 610 on the X-axis and downhole pressure 620 on the left axis. In a representational sinusoidal wave of pressure increasing corresponding with the injection and withdrawal of a working fluid from the fracture 520, one can see that as the pressure is at a maximum the fracture 520 is at the most open, while when the pressure is at a minimum the fracture 520 is the most closed. As noted, FIGS. 5 and 6 are idealized representations of how the fracture or fractures in a geothermal reservoir would dilate during the injection cycle and how the overburden or geostatic pressure from the overlying formations will force the fracture or fractures to constrict when the hydrostatic pressure in the wellbore is reduced or the working fluid is pumped out of the fracture or fractures and/or the wellbore during the production cycle, while FIGS. 4A-4C illustrate recorded experimental data.

It should be noted that the fracture network can be almost any size. In the case shown in FIGS. 4A-4C, a 400 bbl (63.6 kiloliter) fracture network was created, but a 4 million bbl network could similarly be created. Just like a larger tank of carbon dioxide at surface can deliver greater amounts of carbon dioxide than a smaller tank, the size of a downhole reservoir, assuming a sufficiently suitable formation, can easily be sized to match the storage and delivery cycle needed. It should be noted that the size of the storage network will have a small surface footprint regardless of the reservoir size downhole. This compares favorably to the size of a battery/battery network, pumped storage that relies upon hydrostatic pressure, and the like that require a larger surface footprint or area as their storage capacities increase.

FIG. 7 shows a preferred storage reservoir embodiment where a well was drilled to a depth in a sand-shale sequence where diagenesis made the rock impermeable. The data illustrated includes vertical depth 710 on the vertical axis from 0 feet (0 meters) to 19,000 feet (5,791.2 meters) and effective mud weight 720 in pounds per gallon (ppg) on the horizontal axis from 7 ppg (0.84 kilograms/liter) to 21 ppg (2.52 kilograms/liter). The depth of the various diameters of casing 730 segments are plotted near the Y-axis. The graph also includes the formation pore pressure 740 at a given vertical depth; the solid black squares 750 are the mud weight of the fluid in the wellbore; the fracture gradient 760 of the formation at a given vertical depth; the solid triangles 770 are the fracture gradient at the casing shoe test. The wellbore is isolated from the formation via casing or pipe down to or below the top of the diagenetic formation. A fracture network can be induced preferentially downwards towards the center of the Earth as disclosed in International Patent Application No. PCT/US2021/037965 and into more impermeable and hotter rock to create a storage reservoir for the working fluid as discussed above. Generally, once a well has reached a depth where temperatures have created physical and chemical changes in the rock such that porosity and permeability are minimal (usually 350 degrees Fahrenheit or 177 degrees Celsius and above) going deeper to ever higher temperatures will only expose more low permeability rock. Thus, care must be taken when fracturing these low-permeability formations created by diagenesis to avoid the risk of inadvertently or unpreferentially fracturing upwards into a permeable formation with more traditional fracturing technology. By fracking downward using the method disclosed in International Patent Application No. PCT/US2021/037965 and setting a casing into the top of a diagenetic formation, the risk of inadvertently fracturing into permeable rock above the geothermal reservoir-which could be a zone in which the working fluid is lost in part or in whole, or could introduce gases or fluids into our working fluid and thereby contaminating the working fluid-will be reduced.

In summary, recent field trials have generated unexpected results which indicate creating a downhole reservoir in low permeability formations to store and augment off-peak energy for later use during peak demand.

The one or more present inventions, in various embodiments, includes components, methods, processes, systems and/or apparatus substantially as depicted and described herein, including various embodiments, subcombinations, and subsets thereof. Those of skill in the art will understand how to make and use the present invention after understanding the present disclosure.

The present invention, in various embodiments, includes providing devices and processes in the absence of items not depicted and/or described herein or in various embodiments hereof, including in the absence of such items as may have been used in previous devices or processes, e.g., for improving performance, achieving ease and/or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover, though the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A subterranean energy storage system, comprising:
a geothermal reservoir with at least one fracture configured to hold a working fluid for a period of time;
at least one wellbore positioned within the geothermal reservoir fluidly coupled to the at least one fracture;
at least one pump fluidly coupled to the at least one wellbore, the at least one pump configured to at least one of a) inject the working fluid into the at least one fracture of the geothermal reservoir and b) withdraw the working fluid from the at least one fracture of the geothermal reservoir; and,
a power system fluidly coupled to the at least one wellbore, the power system configured to convert at least one of a) a thermal energy of the working fluid and b) a fluid dynamic energy of the working fluid into an electrical current;
wherein a downhole pressure of the working fluid held in the at least one fracture for the period of time increases during the period time.

2. The subterranean energy storage system of claim 1, wherein the electrical current converted by the power system is greater than a sum of i) an injection energy to inject the working fluid into the geothermal reservoir, ii) a withdrawal energy to withdraw the working fluid from the geothermal reservoir, and iii) a lost energy of a portion of the working fluid unrecoverable from the geothermal reservoir.

3. The subterranean energy storage system of claim 1, wherein a permeability of the geothermal reservoir is between 10⁻⁶ to 10⁻⁸ darcies.

4. The subterranean energy storage system of claim 1, wherein the period of time is greater than one hour.

5. The subterranean energy storage system of claim 1, wherein the at least one fracture includes a plurality of fractures.

6. The subterranean energy storage system of claim 5, wherein the at least one fracture extends away from the at least one wellbore and downward towards a center of the Earth.

7. The subterranean energy storage system of claim 1, wherein working fluid is at least one of a) fresh water; b) brine; c) ammonia; d) a hydrocarbon; e) a liquid; f) a gas; and g) a supercritical fluid.

8. The subterranean energy storage system of claim 7, wherein the working fluid is supercritical carbon dioxide.

9. The subterranean energy storage system of claim 1, wherein the power system is at least one of a) a surface turbine and b) a downhole turbine positioned within the at least one wellbore.

10. The subterranean energy storage system of claim 1, wherein the at least one pump is configured to inject the working fluid during an off-peak period of power consumption.

11. The subterranean energy storage system of claim 1, wherein the at least one pump is configured to withdraw the working fluid during a peak period of power consumption.

12. The subterranean energy storage system of claim 1, wherein a downhole temperature of the geothermal reservoir is at least 300 degrees Fahrenheit or 149 degrees Celsius.

13. The subterranean energy storage system of claim 1, wherein the at least one fracture is configured to open when the at least one pump injects the working fluid into the geothermal reservoir and to close when the working fluid is withdrawn from the geothermal reservoir.

14. The subterranean energy storage system of claim 1, further comprising a valve configured to hold the working fluid in the at least one fracture when the valve is in a closed position and to allow the working fluid to flow from the at least one fracture to the power system when the valve is in an open position.

15. The subterranean energy storage system of claim 14, wherein the working fluid is configured to flow from the at least one fracture to the power system under an influence of a geostatic pressure when the valve is in the open position.

16. A method of storing energy in a subterranean energy storage system, comprising:
injecting a working fluid through at least one wellbore positioned within a geothermal reservoir and into at least one fracture in the geothermal reservoir;
holding the working fluid in the at least one fracture for a period of time so that at least one of a downhole temperature of the working fluid and a downhole pressure of the working fluid increases;
withdrawing the working fluid from the at least one fracture, after the period of time, and passing the working fluid through a power system fluidly coupled to the at least one wellbore; and,
converting at least one of a) a thermal energy of the working fluid and b) a fluid dynamic energy of the working fluid into an electrical current with the power system.

17. The method of claim 16, further comprising at least one of opening the at least one fracture when injecting the working fluid into the geothermal reservoir and closing the at least one fracture when withdrawing the working fluid from the geothermal reservoir.

18. The method of claim 16, wherein withdrawing the working fluid from the at least one fracture comprises at least one withdrawing the working fluid at least partly under an influence of a geostatic pressure.

19. The method of claim 16, further comprising fracturing the geothermal reservoir such that the at least one fracture extends away from the at least one wellbore and downward towards a center of the Earth.

20. A method of storing energy in a subterranean energy storage system, comprising:
injecting a working fluid through the at least one wellbore of claim 1 and into at least one fracture in the geothermal reservoir;
holding the working fluid in the at least one fracture for a period of time so that at least one of a downhole temperature of the working fluid and a downhole pressure of the working fluid increases;
withdrawing the working fluid from the at least one fracture, after the period of time, and passing the working fluid through the power system of claim 1; and,
converting at least one of a) a thermal energy of the working fluid and b) a fluid dynamic energy of the working fluid into an electrical current.
